(19) United States
(12) Patent Application Publication
(10) Pub. No.: US 2014/0276022 A1
(43) Pub. Date: Sep. 18, 2014

(54) MICROPOSITIONER AND HEAD HOLDER FOR COCHLEAR ENDOSCOPY

(71) Applicants: The Texas A&M University System, College Station, TX (US); The Board of Trustees of the Leland Stanford Junior University, Palo Alto, CA (US)

(72) Inventors: John S. Oghalai, Stanford, CA (US); Brian Edward Applegate, Bryan, TX (US)

(73) Assignee: The Board of Trustees of the Leland Stanford Junior University, Palo Alto, CA (US)

(21) Appl. No.: 14/205,169

(22) Filed: Mar. 11, 2014

Related U.S. Application Data
(60) Provisional application No. 61/777,807, filed on Mar. 12, 2013.

(51) Int. Cl. A61G 13/12

(52) U.S. Cl. CPC A61G 13/121
USPC 600/427; 128/845; 600/102

(57) ABSTRACT

An apparatus for cochlear endoscopy is provided, comprising a noninvasive head holder with a frame to attach to a head, an otologic tool for examining or operating on an ear, and a manipulator for moving the otologic tool with a translation precision of better than or equal to 0.5 mm. The otologic tool comprises an endoscope.

### CROSS REFERENCE TO RELATED APPLICATIONS

This application claims priority under 35 U.S.C. §119 from U.S. Provisional Patent Application No. 61/777,807, filed Mar. 12, 2013, entitled MICROPOSITIONER AND HEAD HOLDER FOR COCHLEAR ENDOSCOPY, which is incorporated herein by reference for all purposes.

### GOVERNMENT RIGHTS

This invention was made with Government support under contracts W81XWH-11-2-004 awarded by the U.S. Dept. of Defense. The Government has certain rights in this invention.

### BACKGROUND OF THE INVENTION

This invention relates generally to endoscopy. More specifically, the invention relates to cochlear endoscopy.

The auditory system is responsible for transducing traveling pressure waves to sound information that can then be interpreted and experienced by the listener. The system is divided into three main parts: outer, middle, and inner ear. Damage to the structures that comprise these parts can lead to temporary loss of hearing that can ultimately become permanent if not healed or treated properly. Therefore, detection of any abnormalities is very important to ensure prompt and adequate care.

Damage to the cochlea produces sensorineural hearing loss (SNHL) and damage to the vestibular system leads to vertigo, dizziness, and balance disorders. However, there are no imaging techniques that can visualize the critical soft tissue structures within the inner ear responsible for these conditions. Much of the current medical knowledge regarding human SNHL and vertigo is based upon post-mortem temporal bone histology that is typically affected by artifact, audiologic testing techniques that often do not localize the site of the lesion, or studies in animal models that may or may not accurately represent human disease.

### SUMMARY OF THE INVENTION

In accordance with the invention, an apparatus is provided, comprising a head holder, an otologic tool for examining or operating on an ear, and a manipulator for moving the otologic tool with a translation precision of better than or equal to 0.5 mm.

In another manifestation of the invention, an apparatus is provided, comprising a noninvasive head holder, an otologic tool for examining or operating on an ear, and a robotic manipulator for moving the otologic tool with a translation precision of better than or equal to 0.5 mm. The noninvasive head holder comprises a frame to attach to a head and an adjustable arm attached to the frame and which adjustably positions the frame. The otologic tool comprises a wave guide, an end piece comprising an end window to be placed a first distance from an inner ear, wherein the waveguide focuses light to create a focal plane the first distance from the end window, and an optical coherence tomography (OCT) system connected to a second end of the wave guide and comprising an imaging system connected to the OCT system for generating an image of the inner ear

The invention and objects and features thereof will be more readily apparent from the following detailed description and appended claims when taken with the drawings.

### BRIEF DESCRIPTION OF THE DRAWINGS

FIGS. 1a-b are a general view of an embodiment of the invention.

FIGS. 2a-b illustrate an embodiment of the invention.

FIGS. 3a-f shows the results of vibrometry in the living mouse cochlea with sub-nanometer resolution.

FIG. 4 shows a more detailed rendering of the micromanipulator.

FIG. 5 is a schematic illustration of a spectral domain OCT system with an endoscope and a sound system that may be used in this embodiment of the invention.

FIG. 6 illustrates a computer system that may be used in an embodiment of the invention.

FIGS. 7a-b are more detailed schematic views of an endoscope.

FIG. 8a-d are more detailed views of head holders used in embodiments of the invention.

FIG. 9 is a flow chart of an embodiment of the invention.

FIGS. 10 a and b demonstrates a view that may be provide by an embodiment with an OCT imaging device.

FIG. 11 is an image of a cross-sectional area of scala media.

FIG. 12 shows images of the anatomy of the organ of Corti created by an embodiment of the invention.

FIGS. 13 a1-a2 and b1-b3 shows images of a normal Reissner's membrane at various times after blast exposure.

### DETAILED DESCRIPTION OF ILLUSTRATED EMBODIMENTS

Diagnosis can be especially difficult in the inner ear due to its location beyond the tympanic membrane and the relatively small size of its structures. Conventional otoscopes are unable to reach this region of the ear and give physicians the view needed to assess any afflictions to the region. Previous studies into cochlear imaging technologies such as magnetic resonance imaging (MRI) and computer tomography (CT) have shown that while these techniques have the ability to visualize this region they struggle to resolve the smaller structures. Without these details, physicians are left with an incomplete picture of the region. In addition, the imaging protocol for these methods requires the patient to be placed inside the device for an average time of 40 minutes.

This, as well as the long image acquisition time bar these modalities from use during actual surgical procedures. In such a setting, physicians need the most up-to-date information that is possible. The ability to provide real-time information is necessary for adaptation. Hence, a high resolution imaging system with fast acquisition speeds is needed to collect real-time information from a surgical patient with minimal impedance. As well, the ability to do functional imaging, specifically vibrometry, is impeded by the sounds generated by the MRI and CT machines.

Optical coherence tomography (OCT) is a relatively new imaging technology based on low-coherence interferometry. This technique has been widely adapted to the field of ophthalmology and has been used to study tumor morphology, cardiovascular disease, and embryonic development. OCT systems that operate in the frequency domain can acquire a B-scan image in a fraction of a second. OCT also offers an image resolution advantage over MRI and CT. The frequency domain OCT systems generally have an axial resolution of 10 μm and a lateral resolution of 15 μm. While OCT does not have an imaging depth comparable to CT and MRI, it is still capable to imaging 1-2 mm in biological tissue. Thus, OCT offers a balance of resolution, acquisition speed, and imaging depth that makes it a suitable candidate for use in a surgical setting.

As with any imaging system with a limited imaging depth, the orientation of the system and sample are important in order to acquire the best possible image. OCT systems are generally built with a tabletop microscope structure. This allows for a stable platform for imaging by reducing artifacts that can be caused by motion and vibration. While useful for system development and general lab imaging, this configuration is simply impractical to use in a surgical suite. This is especially true if the region of interest is secluded or in a restrictive area of the body as is the case with the cochlea. For this reason, miniaturization and mobility of the sampling arm are crucial to developing a system that can be effectively utilized. The most prevalent method to accomplish this task is to use an imaging probe. Probes are designed for, and utilized by, a number of imaging modalities because they provide access to the region of interest. Handheld probes have become nearly indispensable in today's clinical field due to the ease of use for imaging these regions. However, motion and vibration artifacts from the operator's hand can degrade the overall image quality. This effect is compounded in tightly enclosed regions with delicate structures in close proximity.

For successful cochlear imaging, a different method is needed to deliver the imaging probe through the middle ear canal up to the round window. An embodiment of the invention presents a custom-designed micromanipulator for delivery of an OCT imaging probe for in vivo cochlear imaging of patients undergoing surgical procedures.

In an effort to improve our ability to study animal models of SNHL, an embodiment of the invention uses the technique of optical coherence tomography (OCT) to image the mouse cochlea. It permits quantitative measurements of inner ear anatomy as well as the measurement of sound-induced vibrations of the various structures of the organ of Corti. Importantly, since it does not require opening the surrounding otic capsule bone there is no risk of damaging the inner ear. As part of our basic science research, we have found that OCT can be used to identify anatomic and physiologic changes associated with SNHL in mouse models. Other groups have also used OCT to study the cochlea of mice and other animals for basic research.

An embodiment of the invention facilitates the study the human inner ear by peering through the round window and imaging the basal turn of the cochlea. An embodiment of the invention provides a cochleoscope, which is schematically illustrated in FIGS. 1a-b. FIG. 1a shows a micromanipulator 108 of a cochleoscope 100 attached to a surgical microscope 104 of the cocheoscope 100. FIG. 1b is a schematic view of an endoscope 112 imaging a cochlea 116 through a round window 120 using optical coherence tomography (OCT). Embodiments of the invention show that 1) OCT can be used to reliably obtain anatomic and functional images of the human cochlea and 2) there are anatomical and physiological changes within the cochlear soft tissues associated with SNHL and vertigo that are detectable with OCT. The endoscope 112 is an otologic tool, since it is used to measure the ear. In other embodiments other otologic tools may also be provided that operate on the ear.

A basic tenet of the practice of medicine is that the first step in treating a patient is to make an accurate diagnosis of his/her condition. Unfortunately for the majority of the patients that have hearing loss or vertigo, conclusive diagnosis is not possible due to our inability to interrogate the soft tissues of the inner ear. History has shown that improved treatments follow improved understanding of disease.

Hearing loss afflicts 17% of American adults. Clinical hearing tests are extremely helpful in distinguishing conductive hearing loss (middle ear pathology) from SNHL (inner ear pathology). However, our ability to understand the cellular and tissue changes that occur within the inner ear that cause a patient's SNHL is wholly unsatisfactory. Unlike with diseases of other organ systems, biopsy is not possible. Computed tomography (CT) and magnetic resonance imaging (MRI) techniques provide only gross images of the inner ear, and are typically not helpful. Post-mortem temporal bone histology is affected by cellular degeneration and fixation artifact, and of course, is not helpful in treating an individual patient's problem. In contrast, an embodiment of the invention provides a real-time imaging modality that can produce high-resolution images of the soft tissue structures that cause hearing loss when damaged.

The practice of ENT is limited when a patient complaining of hearing loss is evaluated in clinic. After reading their audiogram, which most commonly functions to document that a patient has SNHL, the rest of the visit is predominantly based upon counseling the patient about tinnitus, hearing aids, cochlear implants, and noise precautions. However, patients and their family members often desire to better understand the reason for their hearing loss and clinicians are often unable to provide this information. One potential immediate benefit of an embodiment of the invention, particularly if the data are interpreted with an understanding of basic research findings in animals and genetic and pathological studies in humans, is that it may allow the clinician to make a meaningful diagnosis of why a patient has hearing loss.

More importantly, the findings are likely to spur the rapid development and testing of novel therapies designed to restore hearing in humans. As new treatments to regenerate hair cells are developed (stem cells, gene therapy, pharmacologic agents, etc.), improved techniques for assessing outcomes will be needed when human trials eventually commence. An embodiment of the invention using OCT provides a way to image the impact of a new treatment on the inner ear in humans that will supplement what can be provided by audiometry.

About 20-30% of the U.S. population have experienced dizziness at some point in the previous year Dizziness is a quagmire because the underlying etiology is often hard to diagnose. Patients with subjective symptoms of dizziness (disequilibrium, vertigo, unsteadiness, lightheadedness, etc.) are often referred to multiple specialists including ENT, neurology, cardiology, and psychiatry. It is common for multiple tests to be performed, such as electronystagmography, MRI, CT, tilt-table testing, and nerve conduction testing. Unfortunately, in many cases no clear cause of the problem can be identified, leading to patient frustration and often re-evaluation and re-testing by even more physicians. Many times, therapy for suspected Meniere's disease may be implemented with little benefit, but with the potential for negative side effects.

An embodiment of the invention using OCT may provide an immediate, objective, and definitive test for endolymphatic hydrops, the pathology underlying Meniere's disease, which afflicts 615,000 patients in the United States. A test for Meniere's disease would be important because if endolymphatic hydrops is identified, an appropriate treatment to reduce the hydrops could be started. As well, the results of treatment could be monitored objectively.

Besides providing a more satisfying experience for the patient, embodiments of the invention would also likely be more cost-effective than the current approach of undergoing multiple tests by multiple specialists. Embodiments of the invention will also improve the ability to understand functional and morphological changes in the inner ear that accompany disease and in addition could herald a paradigm shift in how inner ear disease is diagnosed by providing physical evidence of the diseased state.

There are currently no effective means of imaging the soft tissues within the cochlea or to measure their vibratory responses in a live human. According to an embodiment of the invention, by directing a light beam onto tissue and measuring backscattered light as a function of depth, OCT provides non-invasive subsurface imaging with no contact needed between the probe and tissue. OCT is FDA-approved for clinical use in imaging the eye and the coronary arteries, and is under investigation for use in many other areas of the body. The cochlea is a good organ to study with OCT because the organ of Corti is thin enough for light to penetrate and completely image it. Additionally, the soft tissues are surrounded by clear fluid (perilymph and endolymph), which allow light to pass freely to and from the endoscope.

Tissue biopsy is the standard clinical means of obtaining a diagnosis in a patient with an undiagnosed medical problem. However, a cochlear biopsy is not feasible in humans because it would result in permanent and complete hearing loss. An embodiment of the invention using OCT is non-invasive and because its resolution is nearly at the cellular level, it can provide what has been termed, an “optical biopsy”. The endoscope design in an embodiment of the invention permits OCT imaging through the human round window. Because the round window is so small, standard endoscopes used for sinus or laparascopic surgery will not work. A micropositioning system in an embodiment of the invention attaches to a standard operating microscope and allows the clinician to bring the endoscope to the entrance to the human round window under direct visualization. A head holder in an embodiment of the invention maintains stability when imaging a non-anesthetized patient. Even with a fast 3D scan, the stability provided by embodiments of the invention improves image quality. In addition for vibrometry, stability is critical.

In the specification and claims, “the cochleoscope” refers to all of the components of the OCT system in an embodiment (i.e. the optics, electrical hardware, software, endoscope, micropositioner, and head holder). Some embodiments are developed for use in humans. This was done to follow the convention of naming an endoscopic device after what is being imaged, such as a bronchoscope or colonoscope.

An embodiment of the invention uses spectral domain OCT to generate high-fidelity volumetric images of the mouse inner ear. FIG. 2a is a schematic illustration of the 2^{nd} generation hardware used in an embodiment of the invention. FIG. 2b illustrates the software interface. This embodiment was designed to study the effects of blast exposure on the mouse cochlea. This embodiment used broad-band light centered at 950 nm and was built on a large optical table. In alternative embodiments, a swept laser (Swept-Source OCT source or Optical Frequency Domain Imaging (OFDI) may be used.

A subsequent second embodiment of the invention was then designed to incorporate the important features of the previous embodiment, but was built with portability in mind. This embodiment used a swept-source laser centered at 1310 nm and a single channel photodetector rather than a linear camera with a spectrometer. These changes have eliminated the need for alignment mirrors or lenses whose critical positioning can be easily disturbed. As well, this second embodiment is a fiber-based system, in which all of the optical fibers are attached together using couplers that do not shift out of alignment with the routine jiggling and bumping that must be expected when a device is used in a clinical setting. The embodiment measures the wavelength of the light generated by the swept source and uses this to calibrate the measured photoresponses in order to reduce the phase noise inherent to swept-source systems. This embodiment was housed on a mobile cart that can be easily rolled from the lab to the clinic or operating room. This embodiment was actively used to study both the mouse and the human cochlea.

In this embodiment, software controlled the OCT optics, generate sound stimuli, and collect images and vibratory data from the cochlea. A first generation software was written in MATLAB for convenience. A second generation software was written in LabVIEW for enhanced speed.

Another embodiment provides vibrometry in the living mouse cochlea with sub-nanometer resolution, as shown in FIGS. 3a-f. FIG. 3a illustrates a plastic-embedded cochlear cross-section. Bone is more darkly shaded. The structures of interest are boxed in box 304. The scale bar is 200 μm. FIG. 3b shows an OCT cross-sectional scan of a fixed and decalcified cochlea in vitro. The structures of interest are boxed with box 308. The scale bar is 200 μm. FIG. 3c is a cross-sectional diagram of the key soft-tissue intracochlear structures to be imaged, which are Reissner's membrane (RM) 312, the organ of Corti (OC) 316, basilar membrane (BM) 320, and the auditory nerve fiber (AN) 324. FIG. 3d is a cross-sectional OCT image from a living mouse. To measure vibration, the laser was positioned along the line 328. The white brace 332 shows the depth range of the organ of Corti. The scale bar is 100 μm. FIG. 3e-f are graphs of representative in vivo vibration magnitude and phase data from the organ of Corti at the apex of the unopened mouse cochlea at the location of the representative vibration data 340. The otic capsule bone, a control structure 336 do not vibrate. Vibrations just lateral to the tunnel of Corti (i.e. the region where the outer hair cells sit) were measured. The embodiment demonstrates that mouse organ of Corti vibratory patterns have tuning curves with a non-linear response at the characteristic frequency associated with the cochlear amplifier and a progressive phase lag consistent with a traveling wave. These data are important because they demonstrate that not only can OCT assess intracochlear anatomy in vivo, but that OCT can also measure the physiologic consequences of cochlear amplification. Since many disease states involve outer hair cell pathology, this means that OCT can detect the consequences of outer hair cell dysfunction even if it does not have the resolution to see individual hair cells.

The human inner ear is deep within the head and not easily accessible using existing OCT techniques that are commonly used for imaging the eye through an ophthalmologic microscope. An embodiment of the invention provides a novel endoscopic device to accomplish human inner ear imaging using a minimally-invasive technique that requires inserting the endoscope into the middle ear to approach the round window niche. Imaging is performed by peering through the round window, which is a natural porthole into the cochlea. It is critical to be able to bring the tip of the endoscope to the round window under direct visualization for safety. As well, the endoscope and the patient's head need to be held securely in place to minimize vibrations that would make imaging difficult and vibratory measurements impossible.

### Specific Example

In a preferred embodiment of the invention, a more specific example is provided. FIG. 4 shows a more detailed rendering of the micromanipulator 108. A dovetail assembly 432 at the top allows for easy installation and removal of from the surgical microscopes in the operating room. Since these microscopes are balanced and have electronically-locking stands, the microscope head and the attached endoscope are securely fixed. Motion control is provided by utilizing components from Zaber Technologies, Inc. Rotational movement is driven by a stepper motor 434 with an attached worm gear. The worm gear acts on a rotation gear assembly 436 and allows for 270° rotation. The lateral position 442 of the probe tip 440 in the field of view is determined by a linear actuator 448. Finally, travel in the z-dimension 438 is provided by a linear stage (T-LSM050B) 444 with two inches of travel. All motors are controlled with a single 3-axis joystick that allows for easy, precise placement of the probe tip. Since the micromanipulator 108 may be controlled by a mechanical or electrical device, such as a joystick, the micromanipulator is a robotic micromanipulator.

In order to obtain two-dimensional images a fast-steering mirror (OIM101, Optics in Motion, LLC.) 452 was attached to the end of the linear stage. Collimated light was bounced off the mirror to a relay lens combination and focused into a gradient refractive index (GRIN) lens (024-3490 GRIN relay, Optosigma). The GRIN lens had a 1 mm diameter and an objective lens (024-2270 GRIN objective, Optosigma) attached to the end using UV cured epoxy that is optically clear in the NIR range. To reinforce the rigidity of the lens setup hypodermic tubing was used to surround enclose and protect the GRIN lenses.

FIG. 5 is a schematic illustration of a swept source OCT system with an endoscope and a sound system that may be used in this embodiment of the invention. The OCT is further described in U.S. patent application Ser. No. 13/599,772, entitled “METHOD AND APPARATUS FOR EXAMINING INNER EAR,” filed on Aug. 30, 2012, by Oghalai et al., which is incorporated by reference for all purposes. The light source 504 consisted of swept laser with 50 kHz sweep rate centered at 1310 nm. The light directed into a 1×2 (10:90) fiber coupler 508. One of the output ports was coupled to a circulator 512, which directs some of the light to an endoscope 516, which directs light to scan an inner ear. The circulator 512 directs light reflected from the inner ear and received by the endoscope 516 to a 2×2 (50:50) fiber-fused coupler and polarization maintaining coupler 520. The fiber-fused coupler and polarization maintaining coupler 520 provides output to a first fiber-optic beam splitter 524 and a second fiber-optic beam splitter 528. The output of the first fiber-optic beam splitter 524 is provided to a positive input of a horizontal channel differential amplifier 532 and a positive input of a vertical channel differential amplifier 536. The output of the second fiber-optic beam splitter 528 is provided to a negative input of a horizontal channel differential amplifier 532 and a negative input of a vertical channel differential amplifier 536. The outputs of the horizontal and vertical channel differential amplifiers 532, 536 are provided as input to a Field Programmable Gate Array (National Instruments) 540, which is part of a central computer 544. A sound system 548 is connected to the central computer 544. At least one speaker 552 is connected to the sound system 548. The speaker may be a regular speaker or an ear phone or a special speaker, such as a speaker tube, connected to the endoscope. The sound system 548 and speaker 552 may be separate from the central computer 544 or may be integrated with the central computer 544. Some of the output from the 1×2 fiber coupler 508 is passed through an attenuator 556 and through an in-line polarization controller 560 to an optical delay line box 564. The optical delay line box 564 allows an adjustment to equalize the beam paths through which the light travels. The output of the optical delay line box 564 is provided as input to the 2×2 (50:50) fiber-fused coupler and polarization maintaining coupler 520. An image may be displayed on a video display 570 of the central computer 544.

FIG. 6 is a high level block diagram showing a computer system 600, which is suitable for implementing a central computer 544 used in embodiments of the present invention. The computer system may have many physical forms ranging from an integrated circuit, a printed circuit board, and a small handheld device up to a huge super computer. The computer system 600 includes one or more processors 602, and further can include an electronic display device 604 (for displaying graphics, text, and other data), a main memory 606 (e.g., random access memory (RAM)), storage device 608 (e.g., hard disk drive), removable storage device 610 (e.g., optical disk drive), user interface devices 612 (e.g., keyboards, touch screens, keypads, mice or other pointing devices, etc.), and a communication interface 614 (e.g., wireless network interface). The communication interface 614 allows software and data to be transferred between the computer system 600 and external devices via a link. The system may also include a communications infrastructure 616 (e.g., a communications bus, cross-over bar, or network) to which the aforementioned devices/modules are connected.

Information transferred via communications interface 614 may be in the form of signals such as electronic, electromagnetic, optical, or other signals capable of being received by communications interface 614, via a communication link that carries signals and may be implemented using wire or cable, fiber optics, a phone line, a cellular phone link, a radio frequency link, and/or other communication channels. With such a communications interface, it is contemplated that the one or more processors 602 might receive information from a network, or might output information to the network in the course of performing the above-described method steps. Furthermore, method embodiments of the present invention may execute solely upon the processors or may execute over a network such as the Internet in conjunction with remote processors that shares a portion of the processing.

The term “non-transient computer readable medium” is used generally to refer to media such as main memory, secondary memory, removable storage, and storage devices, such as hard disks, flash memory, disk drive memory, CD-ROM and other forms of persistent memory and shall not be construed to cover transitory subject matter, such as carrier waves or signals. Examples of computer code include machine code, such as produced by a compiler, and files containing higher level code that are executed by a computer using an interpreter. Computer readable media may also be computer code transmitted by a computer data signal embodied in a carrier wave and representing a sequence of instructions that are executable by a processor.

FIG. 7A is a more detailed schematic view of an endoscope 516. The endoscope forms the sample arm of the OCT system. The endoscope comprises a single mode fiber 704, a collimating lens 708, a steering mirror 712, a focusing lens 716, a Gradient Index (GRIN) lens 720, and an end piece 724 at the end of the GRIN lens 720. The steering mirror 712, may be the fast-steering mirror 452, shown in FIG. 4. FIG. 7B is a more detailed illustration of the GRIN lens 720 and end piece 724. In this embodiment of the invention, the end piece 724 is attached directly to an end of the GRIN lens 720. Preferably, the end piece 724 is attached by an adhesive, such as epoxy. In other embodiments the GRIN lens 720 and end piece 724 may form a single object. In other embodiments, the various components of the endoscope may be separated by optical fiber or another optical transmission material. The single mode fiber 704 is an optical fiber that connects the endoscope to the main part of the OCT system and passes light beams 706 between the OCT system and the endoscope. The collimating lens 708 collimates the output of the single mode fiber 704. In this embodiment this is done by placing the face of the fiber in the back focal plane of the collimating lens 708. In this embodiment, the steering mirror 712 is a fast scanning mirror that is a voice coil mirror that can deflect in both x and y. The steering mirror 712 lies in the back focal plane of the focusing lens 716. The focusing lens 716 focuses the collimated light to a point outside the GRIN lens 720. The GRIN lens 720 images the focal spot made by the focusing lens onto the object being imaged. In this embodiment, the magnification of the GRIN lens 720 is 1.

In other embodiments the magnification of the GRIN lens is greater than 1 to provide an increased field of view. In this embodiment, the end piece 724 is a turning prism that uses a silver coated side to direct light at the appropriate angle for viewing the inner ear through a round or oval window. In another embodiment, the end piece has a transmission surface that directs light to the inner ear and then receives light from the inner ear and directs it through the endoscope. Preferably, the GRIN lens 720 and the end piece 724 have a diameter less than 2 mm, more preferably about 1.4 mm with a tip of 1 mm to allow the GRIM lens 720 and end piece 724 to be inserted in an incision in tympanic membrane or a temporal bone to allow the end piece 724 to approach the inner ear. The scanning OCT was designed to be thin enough to access the round window niche, focus the light at the appropriate depth, and angle the light at 90° so that the organ of Corti can be visualized. The endoscopes were built under sterile conditions using medical-grade epoxy and stainless steel tubing. These parts are routinely used in other clinical endoscopes and can tolerate repeated sterilization. The endoscope is sterilized using a hydrogen peroxide low temperature sterilization unit (Sterrad, ASP corp.), which meets the current requirements in California. Lastly, since we need to scan the light in two dimensions, a scan mirror and lens assembly is used to focus the light onto the back aperture of the GRIN lens 208.

Holding the human subject's head steady will be critical for good images and vibration measurements. In this embodiment a head-holder is provided to stabilize the head, as shown in FIGS. 8a-b. FIG. 8a shows the adjustable head holder with a flexible, locking arm 804 attached between the adjustable head holder frame 808 and an anchor 812. The flexible, locking arm 804 may be an articulating arm. FIG. 8b is another view of the adjustable head holder frame 808 supporting a head, while an ear is being examined by a cochleoscope 100. The anchor 812 may be a free standing base, an operating table, or an examination chair, which is sufficiently fixed to prevent the adjustable head holder from moving. In this embodiment, the head holder frame 808 comprises rails 816. An adjustable chin rest 820 is extends between the rails 816. The adjustable chin rest 820 may be moved up or down on rails 816 to adjust for patients particular anatomy. A forehead strap 824 is attached to the rails 816 and may continue around the patient's head to provide a firm fit. The adjustable head holder is designed to stabilize the patients head during cochleoscopy in order to aid in preventing injury and to provide for reliable measurements. The flexible, locking arm allows a patient to be positioned appropriately and then immobilized for the procedure. The head holder clamps around the head, and therefore is noninvasive. The head holder comprises a frame attached to the head and an adjustable arm attached to the frame, which adjustably positions the frame. FIG. 8c is a drawing of another embodiment of the head holder more clearly showing the locking arm 804 and anchor 812. FIG. 8d shows two views of the head holder frame 808, showing a chin rest 820, a forehead strap 824, a forehead rest 828, and a bite bar 832 attached between rails 816, used in this embodiment.

FIG. 9 is a high level flow chart for a method of examining an inner ear using an embodiment of the invention which comprises an endoscope. A head is stabilized using a head holder (step 904). An endoscope 516 is inserted to approach the inner ear (step 908). In the preferred embodiments, an end of the endoscope 516 is inserted through the tympanic membrane or temporal bone or into the ear canal adjacent to the tympanic membrane. Preferably, the end of the endoscope 516 is within a distance of 1 cm from the inner ear. More preferably, there is nothing between the end of the endoscope 516 and the inner ear that would prevent performing spectral domain optical coherence tomography directly on the inner ear.

The endoscope 516 is used to perform OCT on the inner ear (step 912). This may be accomplished by providing a light beam through the endoscope 516 to the inner ear, receiving light reflected from the inner ear, and using the received light to create an image of the inner ear. Sound is provided to the inner ear (step 816). In this embodiment, the central computer 544 sends a command to the sound system 548 to generate a tone through the speaker 552. The speaker generates a tone of one or more frequencies. Preferably, the central computer 544 knows at least one dominant frequency in the tone. An image of the inner ear is provided using the OCT (step 820). At least one dominant frequency in the tone is used to measure vibrational response of the inner ear to sound (step 824). In an embodiment of the invention, a first inverse Fast Fourier Transform (FFT) is applied to the spectral interferogram to convert from spatial frequency to space and then a second FFT is applied to the data to provide the data in the frequency domain. The data is analyzed in view of the dominant frequency. The image of the inner ear is displayed (step 828).

The endoscope will pass through a small incision in the tympanic membrane (eardrum), called a myringotomy. It is important to recognize that performing a myringotomy is a daily part of the medical practice of a private-practice ENT physician and is not considered to be particularly challenging, risky, or time-consuming. This procedure is performed on adult patients during a regular clinic visit while the patient is awake and sitting in the exam chair. Most commonly, it is performed to drain out middle ear fluid and place an ear tube. Myringotomy with placement of ear tubes is one of the ten most frequent surgical procedures performed in the U.S. The reason a tube has to be placed is because otherwise the incision will quickly heal and the fluid will re-accumulate. In an embodiment, the incision will typically be fully healed within 2-3 days.

To test an embodiment, frozen human cadaveric temporal bones were used. These were harvested and then frozen prior to shipping. These specimens are typically not frozen within the first 24-48 hours after the donor has expired and also it is not uncommon for thawing and refreezing to have occurred a couple of times. Thus, artifact from tissue degeneration is high. A cross-section of the human temporal bone at the level of the round window is shown in FIGS. 10 a and b demonstrates a view that may be provide by an embodiment with an OCT imaging device.

Two different temporal bone specimens were imaged through the round window with the OCT setup and they both had similarities to the histology, as shown in FIG. 10b. The round window membrane, basilar membrane, osseous spiral lamina, and spiral ligament were clearly visible. However, we could not appreciate any structures above the basilar membrane (i.e. the hair cell/supporting cell regions or the tectorial membrane). As well, we could not visualize Reissner's membrane. We attribute these missing structures to tissue artifact and not a technical limitation of our system. Our system has an imaging depth of field of ˜1.5 mm (see FIG. 2b for an example), so if these structures were present in the specimen we would have been able to see them.

An embodiment of the invention provides an endoscope with a tip that is able to be brought to and held in front of the round window membrane when directed through the ear canal. Much like how hair cells are successfully patch clamped, the endoscope needs to be stable, precise, and simple. An embodiment provides an endoscope that tolerates sterilization reliably and with no degradation in optical properties. An embodiment provides a head holder that effectively and comfortably immobilizes a patient's head. If the cochleoscope is to be able to be used on awake patients, the head has to be fixed in place.

An embodiment of the invention provides imaging of the basilar membrane, the spiral ligament, the osseous spiral lamina, the tectorial membrane, and Reissner's membrane. In addition, this embodiment provides a good image include having <10 μm axial resolution and a signal-to-noise ratio (SNR)>100 dB against a perfect reflector. This embodiment provides images that are adequate to identify the above-named structures and to diagnose pathology in the mouse cochlea

An embodiment provides a “good vibratory response.” A “good vibratory response” is defined as the measurement of vibrations from at least one position within the cochlea using a minimum of 10 different stimulus frequencies and one stimulus intensity level. As well, the vibratory noise floor should be <0.5 nm. Again, these criteria are commonly met when we perform experiments in mice and they are adequate to record meaningful data. It is important to note that while images only have a resolution of 8-10 μm because of the properties of the objective lens and the bandwidth of the light, vibratory data have much better resolution (fm range with a perfect reflector). Furthermore, room vibrations are low frequency and are minimized through Fourier transformation to limit the analysis to frequencies >500 Hz.

The technique of OCT itself is not dangerous to the cochlea. OCT is FDA-approved for use in the eye and is a regularly-used tool in nearly every ophthalmologist's office. ANSI limits for continuous exposure of 1300 nm light is 15.4 mW to the eye and 96 mW to the skin. The cochleoscope has a light intensity of <10 mW after it leaves the tip of the endoscope.

An embodiment of the invention further mounts a calibrated speaker, such as an E-A-R-Tone Gold 3A 410-3001, E-A-R Auditory Systems, Indianapolis, Ind., to the shaft of the endoscope so that it's opening is positioned at the opening of the ear canal. The scan mirror is place so that the beam images across the basilar membrane, just lateral to the tunnel of Corti. Thus, vibrations from all depths that this beam crosses can be measured, including the middle portion of the basilar membrane. This embodiment may present sine wave tones ranging from 500 Hz to 25 kHz ranging from 30 to 80 dB SPL. During each sound stimulus, the OCT system will be repeatedly sampled and FFT analysis will be done to identify the magnitude and phase of vibration of each voxel along the beam path. Data from several voxels at the level of the basilar membrane will be averaged to lower the noise floor further and generate tuning curves. The characteristic frequency (the resonant frequency at the lowest stimulus level; CF), the slope of the vibratory growth curve at the characteristic frequency (the increase in vibration magnitude divided by the stimulus intensity), and the tuning curve sharpness (Q_{10dB}) will be calculated, as indicated in Table 1.

TABLE 1
Anatomical and physiological measurements to be made using OCT

| | Units |
|---|---|
| Anatomical Measurements | |
| Spiral ligament area (SL) | μm² |
| Scala media area (SM) | μm² |
| Tectorial membrane area (TM) | μm² |
| Sub-tectorial space area (STS) | μm² |
| Length of the basilar membrane length (BM) | μm |
| Height of the hair cell epithelium at the tunnel of Corti (HC) | μm |
| Thickness of the osseous spiral lamina at | μm |
| Reissner's membrane attachment (OSL) | |
| Physiological measurements | |
| Characteristic frequency (CF) | kHz |
| Growth curve slope | dB/dB |
| Q_{10 dB} | — |
| Phase at CF | Rad |
| Slope of the phase roll-off at CF | Rad/kHz |

An embodiment measures the spatial patterns of vibration across a cross-section of the organ of Corti by scanning over the tissue of interest during sound stimulation. Preliminary data in mice suggest that such measurements may be valuable, as shown in FIG. 12. Tecta transgenic mice were studied, which re-capitulate a human hearing loss mutation. In this mouse strain, wild-type mice have a normal tectorial membrane, heterozygous mice have a malformed tectorial membrane that only contacts the first row of outer hair cells, and homozygous mice have a tectorial membrane that is elevated off the epithelium. This embodiment only imaged the anatomy of the organ of Corti, but also measured the spatial pattern of vibrations to a sound stimulus presented at the characteristic frequency. As shown in FIG. 12, a sound stimulus was presented at the characteristic frequency (8 kHz) and an intensity of 80 dB SPL. The left column shows images with arrows, which demonstrate the characteristic pathologic findings of the altered tectorial membrane anatomy. While wild-type mice have a tectorial membrane that rests against the hair cell epithelium, there is more space between the tectorial membrane and the hair cell epithelium in heterozygous mice. This effect is even greater in homozygous mice and the top of the tectorial membrane curves inward rather than outward. The middle column only shows voxels with vibration magnitudes above the noise floor are pseudoshaded. The magnitude of basilar membrane vibration, indicated by the lower arrows, is partially reduced in heterozygous and severely reduced in homozygous mice. The effect is even more pronounced for the tectorial membrane, as indicated by the upper arrows. The right column illustrates the vibration phase with mid-basilar membrane set at 0°. The phase of the region where the Henson cells sit, as indicated by the arrows, is altered relative to that of the hair cells which sit just to the left. An important point is that there are clear anatomic and physiologic differences between the genotypes that are distinguishable with OCT. Thus, if a patient with hearing loss presents to an ENT clinic, these data demonstrate that this embodiment would be able to determine if the problem involved the tectorial membrane.

While OCT in an embodiment does not provide the resolution necessary to see individual hair cells, loss of hair cells is associated with thinning of the epithelial surface, which has been termed “sensory presbycusis” in patients with age-related hearing loss. Since hair cell loss is a common feature associated with nearly all forms of hearing loss, we expect that the thickness of the hair cell region will be reduced in patients with hearing loss. Another feature often described in states of SNHL is atrophy of the stria vascularis, also termed “strial presbycusis”. A reduced cross-sectional area of the spiral ligament is expected to be found with this condition.

Physiologically, SNHL is almost always associated with loss of the cochlear amplifier. An embodiment determines if there is reduced non-linearity of basilar membrane vibratory tuning curves. Specifically, the slope of the growth curve will be increased (closer to a linear slope of 1 dB/dB) and the Q_{10db} will be reduced (indicating that cochlear tuning is less sharp).

Classically, patients with Meniere's disease have episodic vertigo, aural fullness, fluctuating hearing loss, and low-pitched tinnitus. However, most patients with vertigo have some of these components, but not all. Thus, subcategories have been developed by the American Academy of Otolaryngology—Head and Neck Surgery to try to define patients with symptoms that may reflect Meniere's disease. These categories include: (1) Possible Meniere's disease—patients with definitive vertigo episodes but no hearing loss. (2) Probable Meniere's disease—patients with only one definitive episode of vertigo but who also have hearing loss and tinnitus. (3) Definite Meniere's disease—patients that have had two or more episodes of vertigo with hearing loss plus tinnitus and/or aural fullness. (4) Certain Meniere's disease—patients who had definite disease with histopathological confirmation (i.e. they died and they were found to have endolymphatic hydrops when their temporal bones were sectioned). While these categories are helpful clinically when managing patients, honestly, they are vague. In fact, if cochleoscopy, using an embodiment of the invention, can readily provide optical confirmation of endolymphatic hydrops in living patients, the diagnostic and treatment protocols for vertigo will likely undergo substantial modifications.

An embodiment compares the cross-sectional area of scala media, as shown in FIG. 11, in patients with normal cochlear function and no vertigo and those with definite Meniere's disease. Patients with definite Meniere's disease are not operated on, as many can be effectively treated with lifestyle changes and medical management. However, there are some patients that are not responsive to these conservative therapies. Some elect to undergo endolymphatic sac shunting or labyrinthectomy.

An embodiment of the invention can detect endolymphatic hydrops, as shown by the detection in mice. As part of our research into blast-induced hearing loss live mice after blast exposure have been imaged. Examples from two mice are shown in FIG. 13. FIG. 13 a1 is an image 2.5 hrs after blast exposure, showing that Reissner's membrane was distended outwards consistent with endolymphatic hydrops. FIG. 13 a2 is an image after the mouse was then sacrificed and 4 hrs later, where Reissner's membrane was sunken in. FIG. 13 b1 is an image of a normal Reissner's membrane immediately after blast exposure. FIG. 13 b2 shows a distended Reissner's membrane 2 hours later; after the mouse was then sacrificed. FIG. 13 b3 shows a normal Reis sner's membrane 30 minutes after sacrifice. Two hours after the blast, endolymphatic hydrops was noted by the outward distension of Reissner's membrane, as shown in FIG. 13 a1 and FIG. 13 b2. The mice were sacrificed and within 4 hrs, Reissner's membrane was noted to be sunken in, as shown in FIG. 13 a2. Thus, an embodiment of the invention can detect dynamic changes in Reissner's membrane that would not otherwise be detectable. This embodiment will provide the first definitive test for endolymphatic hydrops.

In various embodiments, the diameter of the endoscope is chosen using a trade off of a larger diameter endoscope would increase image resolution, while a thinner endoscope may be easier to use and may interfere less with the diagnostic process.

In some embodiments, a cochleoscope in the ear canal and passing through a myringotomy may cause conductive hearing loss and impact the ability to present accurate sound stimuli to the ear. Some embodiments get around this potential issue by presenting the sound to the ear canal while using OCT to image the cochlea though a separate opening in the middle ear bulla created surgically. In some embodiments, ear tubes that are inserted into the tympanic membrane do not cause hearing loss, and they are roughly the same diameter as the shaft of the cochleoscope. If this is a substantial issued, some embodiments normalize the magnitude of basilar membrane vibration to that of the ossicular chain.

Understanding the cellular and tissue changes that occur within the inner ear and cause SNHL is problematic. Current CT and MR imaging techniques provide only gross images of the inner ear, and are not helpful. Post-mortem temporal bone histology is affected by cellular degeneration and fixation artifact, and of course, is not helpful to treating that individual patient's problem. An embodiment of the invention provides a real-time imaging modality that produces high-resolution 3D images of the soft tissue structures that cause hearing loss when damaged.

As new treatments to regenerate hair cells are developed (stem cells, gene transfection, pathway inhibiting drugs, etc.), improved techniques for assessing outcomes will be needed when human trials eventually commence. An embodiment of the invention will provide a way to image the impact of a new treatment on the inner ear in humans that are enrolled in these trials that will supplement what can be provided by audiometry.

The diagnosis of vertigo, dizziness, and/or disequilibrium is difficult. Patients with these symptoms are often referred to multiple specialists including ENT, neurology, cardiology, and psychiatry. It is common for multiple tests to be performed, such as MRI, CT, tilt-table testing, nerve conduction testing, etc. Unfortunately, in many cases no clear cause of the problem can be identified, leading to patient frustration and often re-evaluation and re-testing by even more physicians. Many times, therapy for suspected Meniere's disease may be implemented with little-to-no benefit. An objective test for endolymphatic hydrops could quickly determine if this is a factor in causing a patient's symptoms. Besides providing a more satisfying experience for the patient, it would also likely be a more cost-effective strategy than the current approach of undergoing multiple tests by multiple specialists.

In other embodiments, in place of a microscope, other image amplifiers, such as a large video display may be used. In some embodiments, the micromanipulator has a precision better than or equal to 0.5 mm. More preferably, the micromanipulator has a translation precision of greater than or equal to 0.1 mm. In a preferred embodiment, the micromanipulator provides rotation and tilt precision of better than or equal to 20°. More preferably, the micromanipulator provides rotation and tilt precision of better than or equal to 1°. Preferably, the head holder is noninvasive, which means that such a holder does not, for example require screwing directly to the skull.

While this invention has been described in terms of several preferred embodiments, there are alterations, permutations, modifications and various substitute equivalents, which fall within the scope of this invention. It should also be noted that there are many alternative ways of implementing the methods and apparatuses of the present invention. It is therefore intended that the following appended claims be interpreted as including all such alterations, permutations, modifications, and various substitute equivalents as fall within the true spirit and scope of the present invention.

What is claimed is:

1. An apparatus, comprising:
a head holder;
an otologic tool for examining or operating on an ear; and
a manipulator for moving the otologic tool with a translation precision of better than or equal to 0.5 mm.

2. The apparatus, as recited in claim 1, wherein the manipulator is a robotic manipulator.

3. The apparatus, as recited in claim 2, further comprising an image amplifier, such as a microscope or video display.

4. The apparatus, as recited in claim 3, wherein the robotic manipulator further provides a rotation and tilt precision of better than or equal to 20°.

5. The apparatus, as recited in claim 4, wherein the head holder is noninvasive.

6. The apparatus, as recited in claim 5, wherein the head holder comprises:
a frame to attach to a head; and
an adjustable arm attached to the frame and which adjustably positions the frame.

7. The apparatus, as recited in claim 6, wherein the robotic manipulator further provides a rotation and tilt precision of better than or equal to 1°.

8. The apparatus, as recited in claim 7, wherein the robotic manipulator has a translation precision of better or equal to 0.1 mm.

9. The apparatus, as recited in claim 8, wherein the otologic tool comprises an endoscope.

10. The apparatus, as recited in claim 9, wherein the endoscope comprises:
a wave guide; and
an end piece comprising an end window to be placed a first distance from an inner ear, wherein the waveguide focuses light to create a focal plane the first distance from the end window.

11. The apparatus, as recited in claim 10, wherein the otologic tool further comprises an optical coherence tomography (OCT) system connected to a second end of the wave guide and comprising an imaging system connected to the OCT system for generating an image of the inner ear.

12. The apparatus, as recited in claim 11, wherein the waveguide and end piece have a diameter no greater than 4 mm.

13. The apparatus, as recited in claim 12, wherein the end piece further comprises a reflector surface.

14. The apparatus, as recited in claim 13, wherein the first distance is between 4 mm and 16 mm.

15. The apparatus, as recited in claim 11, further comprising a sound system comprising:
a sound generator for generating a sound with at least one frequency; and
a controller for controlling the at least one frequency; and
an output device for outputting the at least one frequency.

16. The apparatus, as recited in claim 1, wherein the head holder is noninvasive.

17. The apparatus, as recited in claim 16, wherein the head holder comprises:
a frame to attach to a head; and
an adjustable arm attached to the frame and which adjustably positions the frame.

18. An apparatus, comprising:
a noninvasive head holder, comprising:
a frame to attach to a head; and
an adjustable arm attached to the frame and which adjustably positions the frame;
an otologic tool for examining or operating on an ear, comprising:
a wave guide;
an end piece comprising an end window to be placed a first distance from an inner ear, wherein the waveguide focuses light to create a focal plane the first distance from the end window; and
an optical coherence tomography (OCT) system connected to a second end of the wave guide and comprising an imaging system connected to the OCT system for generating an image of the inner ear; and
a robotic manipulator for moving the otologic tool with a translation precision of better than or equal to 0.5 mm and a rotation and tilt precision of better than or equal to 20°.
